(19) United States
(12) Patent Application Publication
(10) Pub. No.: US 2005/0075987 A1
(43) Pub. Date: Apr. 7, 2005

(54) Method for capturing and processing information in a communication system

(75) Inventors: Leon A. Pintsov, West Hartford, CT (US); Andrei Obrea, Seymour, CT (US)

Correspondence Address: Ronald Reichman;Pitney Bowes Inc., 35 Waterview Drive, P.O. Box 3000, Shelton, CT, 06484, US

(73) Assignee: Pitney Bowes Incorporated, Stamford, CT (US)

(21) Appl. No.: 10/944,991

(22) Filed: Sep. 20, 2004

Related U.S. Application Data
(60) Provisional application No. 60/509,344, filed on Oct. 7, 2003.

(51) Int. Cl. G06F 17/60

(52) U.S. Cl. 705/401

(57) ABSTRACT

The postal operator or carrier completes an “incomplete” address or modifies or overrides elements of the address that were misprinted or are unreadable, and forwards the corrected address to the sender for the sender's subsequent use. The foregoing will allow the sender to take advantage of postal operator's work sharing and postal discounts.

This Application claims the benefit of the filing date of U.S. Provisional Application No. 60/509,344 filed Oct. 7, 2003, which is owned by the assignee of the present Application.

### FIELD OF THE INVENTION

This invention relates to the gathering of information and, more particularly, to gathering, processing and distributing information systems for mailing and shipping systems.

### BACKGROUND OF THE INVENTION

Track and trace systems have been developed for the shipping and mailing of mail entities, i.e., letters, flats, packages, collection of letters and/or collection of flats wherein a collection of mail entities may be assembled together in a single container (e.g., tray, sack) or a collection of containers assembled together and being referred to as a unit (e.g., palette, conveyance or shipment). Typically, those systems reflect the progress of the mail entity through a distribution network operated by the postal operator, i.e., United States Postal Service (USPS) or through an independent carrier infrastructure.

Current track and trace systems provide information regarding the location and nature of sequential delivery steps in the flow of the mail entity from a sender to a recipient.

One of the problems of current track and trace systems is that when there is some error in the recipient's address, i.e., incomplete street address, that may be corrected by the postal operator or carrier's system using an electronic address data base such as the USPS' Address Matching System, the sender does not have access to corrected information or the address in the data base, because the process of looking up the address in the data base is expensive, or because the postal operator does not allow for such an access.

An additional problem of current track and trace systems is that the letter carrier may make a correction to an incorrect address based upon the carrier's judgment and experience, i.e., Charles Johnson lives at 5 Glen Street, not 5 Elmherst Street. The foregoing is expensive and time-consuming to the postal operator, and it does not notify the sender of the correct address. Thus, the sender may continue to send mail entities to an incorrect address, risking that the mail entity may not be delivered at another occurrence.

Yet another problem of current track and trace systems in general is that the useful information about the mail entity defects, e.g., skewed address or unreadable print font that is typically captured within postal environment is not being shared with mailer responsible for defects.

The foregoing problem is exacerbated when major mailers have many incorrect addresses. This problem is increased if the mail entity contains valuable information or valuable objects, i.e., jewelry, credit cards, etc.

### SUMMARY OF THE INVENTION

This invention overcomes the disadvantages of the prior art by having the postal operator or carrier complete an incomplete address or modify or override elements of the address that were misprinted or are unreadable and forward the corrected address to the sender for the sender's subsequent use. The foregoing will allow the sender to take advantage of USPS work sharing and postal discounts.

The postal operator or carrier will capture, store and communicate to the sender information regarding the attributes of information present on the mail entity that made the information on the mail entity unreadable or more generally unprocessable, i.e., position and format of the information on the mail entity is incorrect, the print quality has certain attributes with values outside the acceptable processability ranges of the mail entity, etc. The foregoing problems are referred to as technical problems. The solution to technical problems implies that information from the mail entity is captured and interpreted or classified by the postal operator without any imperfections or errors.

An example of another type of problem is when the information is defective, meaning the information on the mail entity does not allow for interpretation needed for mail processing and delivery, i.e., address 1035 Waterview Drive, Shelton, Conn., does not exist. The foregoing problem is referred to as a semantic problem. Some semantic problems may be correctable, i.e., if the address as printed on the mail entity has only one different and correct address closely approximating the printed address, i.e., 1035 Waterview Drive, Shelton, Conn., but 1085 Waterview Drive, Shelton, Conn. exists, and there is no other meaningful address within the above address street range. In the above case, it can be safely assumed that the sender most likely meant the correct address, i.e., 1085 Waterview Drive, Shelton, Conn. and, thus, the mail entity can be correctly delivered to the correct address. However, in the case of technical and semantic problems, it is desirable to provide a feedback to the sender containing sufficient correct information. The corrective information and possible additional expenses incurred by the postal operator can be a basis for postal surcharges or price adjustments.

Preferences are generally defined as information elements that should guide the postal operators and mailers in providing mailing services according to recipients' desires, for example, time and place for delivery, preferences in not receiving mail from certain mailers, etc. Preferences are generally variable parameters that can change on a daily or hourly basis. The pointers to preferences records can be fixed or variable, depending on economic considerations associated with physical changes to the information represented by the pointers, i.e., apartment buildings with frequent changes of renters. Pointers can represent Universal Resource Locator (URL) or Universal Resource Identifier (URI) type of data. Privacy of the information contained in the database of preferences can be protected by providing access to indices/pointers that point to records (or information in database generally) only to authorized users, i.e., users in possession of a scanner with cryptographic secret key. Computerized records of preferences and general desires of recipients can be created by mail recipients by creating a record in a database. The database can be made accessible to various parties, including but not limited to, the postal operators/carriers and mailers/senders. A specially designed information pointer that can be represented physically in a machine-readable format on mail receptacles can index the records in the database containing recipient's preferences. The foregoing may be accomplished by using laminated labels containing 2-D bar codes or RFID tags or the like.

In other words, the recipient's preferences and other variable information may be captured in a data base that is not associated with the postal operator or a carrier. A pointer would exist on the recipient's mailbox to the information in some external data base. Appropriate access rights are provided to the data base so that the postal operator and/or carrier may make use of the information in the data base.

### BRIEF DESCRIPTION OF THE DRAWING

FIG. 1 is a drawing showing the relationship between the mail entity events in the processing and delivery of the mail entity, and activities which comprise the above events;

FIG. 2 is an example of information being captured and processed as the information relates to events and activities described by the structure in FIG. 1 in the case of the processing of a delivery address block that takes place in a postal operator sortation facility;

FIG. 3 a drawing of a mail entity;

FIG. 4 is a drawing of a mail entity that is uniquely linked to mail entity identifier 35 of FIG. 3;

FIG. 5 is a drawing of a mail communication system;

FIG. 6 is a drawing of the mailer process flow;

FIG. 7 is a drawing of the recipient process flow;

FIG. 8 is a drawing of a mail box with a Correct Address Information Record (CAIR) label; and

FIG. 9 is a drawing of a CAIR label.

### DETAILED DESCRIPTION OF A PREFERRED EMBODIMENT

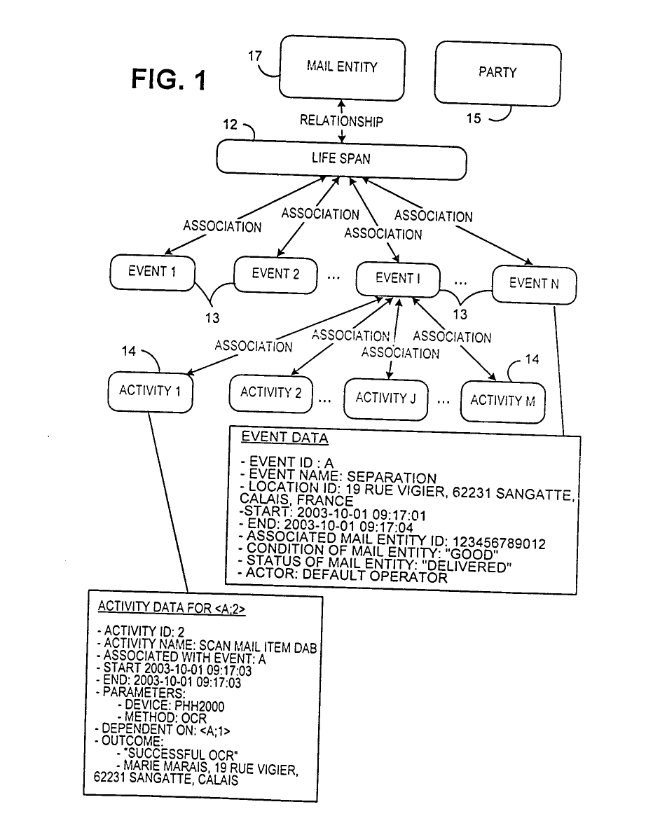

Referring now to the drawings in detail and more particularly, to FIG. 1, the reference character 11 represents a mail entity that has events 13 in its life, namely, the production of the mail entity, the applying of postage to the mail entity, the induction of the mail entities into the mail stream, the sortation of the mail entities by the postal operator, the changing of custody of the mail entity from one carrier to another carrier, i.e., from the USPS to the Royal Mail, and the delivery of mail entity 11 to the recipient's mail box.

Life span 12 is a logical structure that contains information that relates events 13 to mail entity 11 during the life of mail entity 11.

Activities 14 is associated with events 13 in such a manner that the event 13 is comprised of a multiplicity of activities 14. By exposing the internal structure of events 13 as a sequence of activities 14 and the information associated with the events and activities, additional services can be delivered and additional information, such as address correction information, will be sent to the sender in real time.

Party 15 is a legal “entity” that has relation (interest, obligation), control or ownership of mail entity 11 at least some period of time during the life span of mail entity 11. Some examples of a “mail entity” are a letter, a flat, a parcel, a tray of letters, a pallet of trays, or a roller case. In all instances a mail entity is a physical object that can be positioned in space and time.

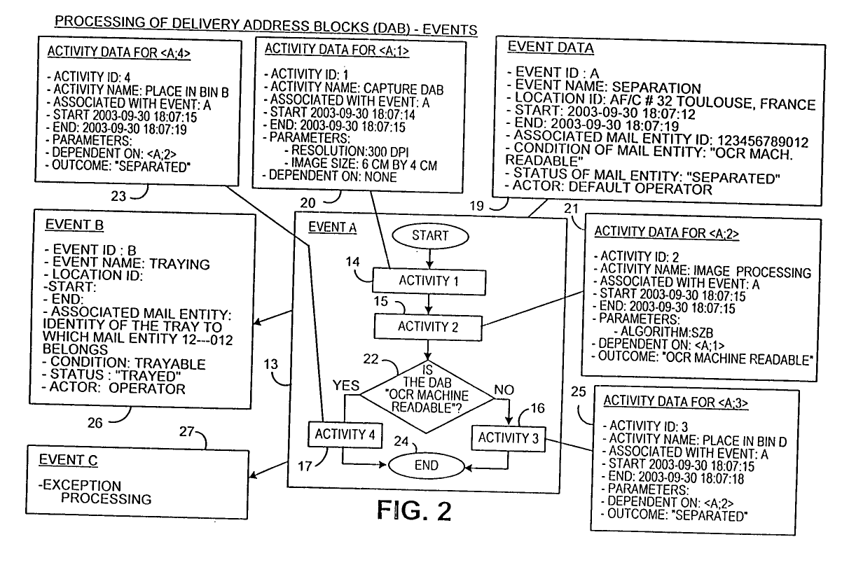

In FIG. 2, it is assumed that a mail entity is being sorted in a postal operator sortation facility. The sortation includes a number of events, but only three are shown in FIG. 2: event A, event B and event C, for illustration purposes, i.e., separation, sort using optical character recognition (OCR), and remote computer reading. Other events are obvious to one skilled in the art. Depending on the content of the information in the destination address block of the mail entity, one or more of the above events may take place before the processing is considered complete. Upon completion of activities 14-17, the event data block 19 is captured. Data block 19 consists of Event ID: A, event name “separation”, location ID: AF/C #32 Toulouse, France, Start: 2003-09-30 18:07:15; End: 2003-09-30 18:07:15, parameters; algorithm identifier SZB, dependent on <A 1>, outcome: OCR machine-readable.

For example, the work flow for event A is the completion of activities 14 through 17. Activity 14, which is capture of the information contained in the delivery address block (DAB) of the mail entity. Block 20 indicates the type of information that has been captured upon completion of activity 1, namely, ActivityID: 1; Activity Name; Capture DAB; Associated with Event: A; Start:date 2003-09-30 18:07:14; End date: 2003-09-30 18:07:15; Parameters: resolution: 300 dpi and Image size: 6 cm by 4 cm; and Dependent on: none.

Activity 15 represents image processing, i.e., the processing of the image captured in activity 14. Block 21 indicates the type of information we want to capture upon completion of activity 2, namely: Activity ID: 2; Activity Name: Image Processing; Associated with Event: A; Start date: 2003-09-30 18:07:15; End date: 2003-09-30 18:07:15; Parameters: Algorithm identifier: SZB; Dependent on: <A;1>; Outcome: “OCR Machine Readable”.

The process reverts to decision block 22. Block 22 determines DAB on the mail entity contains information that is machine-readable. If block 22 determines that the information is machine-readable, the next step is block 17 indicated as Activity 4. Block 23 indicates the type of information that needs to be captured upon completion of activity 4, namely: Activity ID: 4; Activity Name: Place in Bin E; Associated with Event: A; Start date: 2003-09-30 18:07:15; End date: 2003-09-30 18:07:19; Parameters: Dependent on: <A;2>; Outcome; “Separated/Sorted”.

Then the event is completed in block 24 and is followed by the next event that may be represented for illustrative purpose by block 26, i.e., event B, or block 27, i.e., event C. Block 26 indicates event ID: B, event name “traying”, location, start time, end time, associated mail entity, identity of the tray to which mail entity belongs, condition “trayable”, status “trayed” and action, “operator”. Block 27 indicates event C, exception processing.

If block 22 determines that the information is not machine-readable, the next step is block 14 indicated as activity 3. Block 25 indicates the type of information that needs to be captured upon completion of activity 3, namely: Activity ID: 3; Activity Name: Place in Bin D; Associated with Event: A; Start date: 2003-09-30 18:07:15; End date: 2003-09-30 18:07:18; Parameters: Dependent on: <A;2>; Outcome: “Separated”.

Then the event is completed in block 24 and is followed by the next event which may be block 26, i.e., event B, or block 27, i.e., event C.

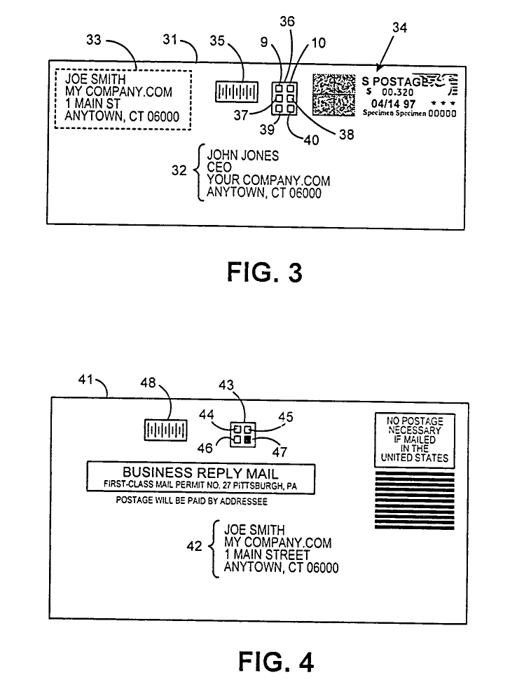

FIG. 3 is a drawing of mail entity 31. Mail entity 31 has a recipient delivery address block 32, an origination address block 33, a digital indication of postal payment (digital postage mark) 34, a mail entity identifier 35, and a service indicator 36. Service indicator 36 has blocks 9, 10, 37, 38, 39 and 40 that may be checked to indicate the requested service. Block 9 is used to indicate services that may be requested by the sender for information that is needed to correct technical defects on the face of the mail entity and block 10 is used to indicate services that may be requested by the sender for information that is needed to correct information present on mail entity (semantic defects). Blocks 37-40 contain information defining what should happen to mail entity 11 if the services as requested can not be performed because of incorrect address information, or the services can not be performed within the allotted time, (i.e., mail entity 31 is time-sensitive, i.e., notification of a sale to take place on Monday, October 1). Thus, the sender does not want mail entity 31 to be delivered after October 1. For example, a check mark in block 37 can indicate that mail entity 31 would need to be physically destroyed if it could not be delivered passed a indicated date, for example passed Apr. 17, 1997, which is three (3) days past the date indicated in the digital postage mark 34. Similarly, block 38 may indicate that mail entity 31, must be returned to a person identified in origination address block 33 after Apr. 17, 1997. Blocks 39 and 40 may indicate alternate locations for the disposal of mail entity 31, i.e., a predetermined and agreed upon post office box located at Anytown, Conn. 0600 as indicated in the destination address block 32.

Mail processing and sorting equipment is programmed to automatically determine in the case of incorrectly addressed but deliverable mail whether the requested service by the mailer can be performed within the time constraints specified by the mailer and not performed by the delivery process in accordance with the customer's request. For example, the normal time periods for delivery of mail entities originating and having a destination in major postal network distribution hubs are stored within the processing memory of mail processing and sorting equipment. Thus, the post avoids unnecessary costs, and the mailer and the recipient avoid unnecessary aggravation.

The above arrangement may serve as a basis for management of a date-certain delivery service whereby the postage or part thereof may be credited to the mailer's account if mail entity 31 can not be delivered as required due to an incorrect address and requested delivery time. The post creates all diagnostic information containing the reason for non-delivery of mail entity 31 or corrects the address and communicates this information to the mailer.

FIG. 4 is a drawing of a mail entity 41 that is uniquely linked to mail entity identifier 35 of FIG. 3. Mail entity 41 may be Business Reply Mail that is contained in mail 31. Mail entity 41 has a recipient data address block 42, a service indicator 43, and a mail identifier entity 48 that is uniquely linked to mail identifier entity 35 (FIG. 3). Service indicator 43 has blocks 44, 45, 46 and 47, which are similar to blocks 37-40 (FIG. 3). Block 47 is marked to indicate that John Jones, CEO Your company.com, 3 Main St., Anytown, Conn. 06000 (FIG. 3) has a new address.

If data address block 32 (FIG. 3) contains correctable errors, so that the mail entity 31 is deliverable by a corrective process that is depicted in FIGS. 1 and 2, the mailer of mail entity 31 will receive all information needed for corrective action. The mailer of mail entity 31 may respond to a request identified by the recipient of mail entity 41, i.e., John Jones, even if John Jones did not write corrected address information in mail entity 41. John Jones only has to mark block 47 to indicate that he has a new address, and John Jones' new address will be communicated to the mailer of mail entity 31.

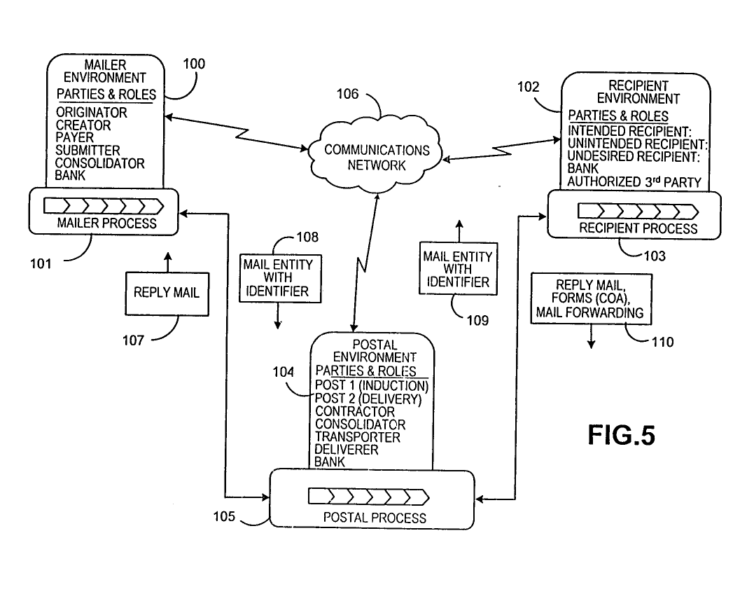

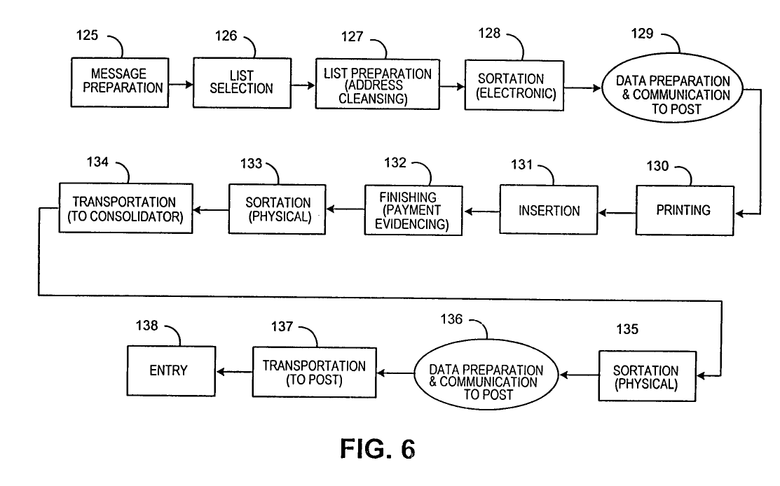

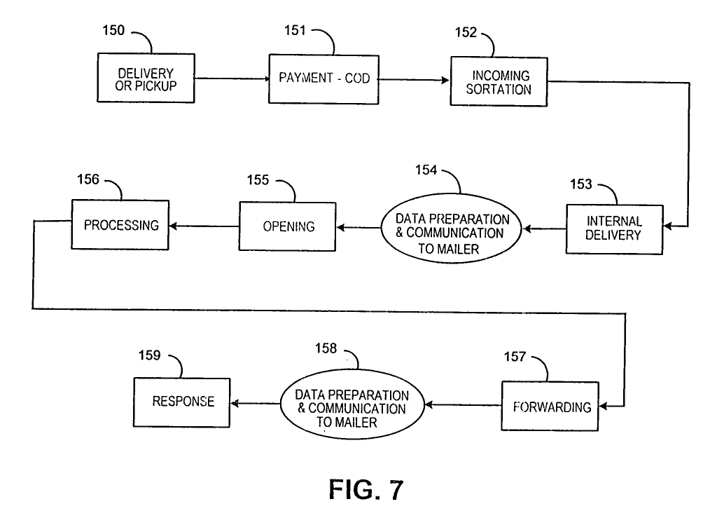

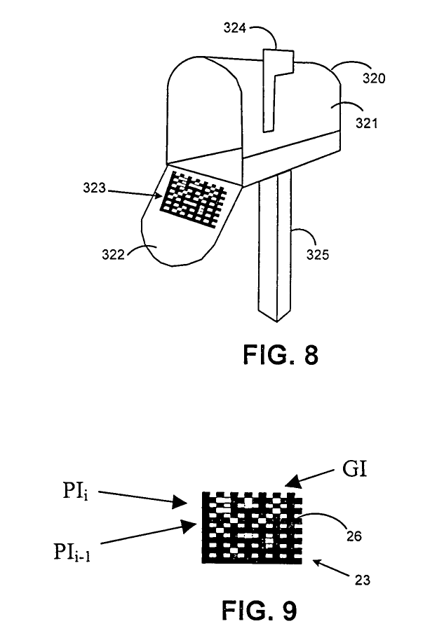

FIG. 5 is a drawing of a mail communication system. Block 100 shows the parties and roles in the mailer environment namely, originator, creator, payer, submitter, consolidator and bank. Block 101 shows the mailer process flow. The mailer process flow is more fully described in the section explaining FIG. 6. Block 102 shows the parties and roles in the recipient environment namely, intended recipient, unintended recipient, undesired recipient, bank, and authorized third party. Block 103 shows the recipient process flow. The recipient process flow is more fully described in the section explaining FIG. 7. Block 104 shows the parties and roles in the postal environment namely, post 1 (induction), post 2 (delivery), contractor, consolidator, transporter, deliverer, and bank. Block 105 shows the postal process flow. The postal process flow is more fully described in the description of FIG. 8.

Blocks 100, 102 and 104 may electronically communicate with each other via communication network 106, i.e., Internet, telephone, facsimile. Money and information may be transmitted over network 106. Postal process 105 may be used to transmit physical information, and physical objects to and from mailer process 101 to recipient process 103.

Block 108 shows mail entity 3 with identifier 31 travelling through the postal distribution system.

Block 109 shows mail entity 31 with identifier 35 arriving at recipient environment 102.

Block 110 shows a reply mail entity 41 that has been submitted by the recipient for delivery to the sender.

Block 107 shows reply mail 41 arriving at the original mailer environment 100. Communications network 106 enables the exchange of computerized information between mailer, postal and recipient environments.

The above computerized information can be beneficial about mail item itself or physical structures and objects that pertain to the physical structure of the address designated by the address 32 (FIG. 3) or information concerning the mail distribution process itself. For example, if the weight of the mail item is measured in the sender postal and recipient environments and found to be different at different times and locations during the distribution process, these discrepancies could be indicative of theft or adverse environmental conditions or security risks. The increase or decrease of the weight may be reported to the sender or a third party law enforcement agency.

FIG. 6 is a drawing of the mailer process flow. Message preparation is performed in block 125. Then list selection is performed in block 126. Followed by list preparation and address cleansing in block 127. Electronic sortation is performed in block 128. At this point data preparation and communication to the post is performed in block 129. In the printing process in block 130, electronic information is presented in a physical form (printing). Then in block 131 the printed information is inserted into mail entities. In the finishing process, payment and evidencing functions are accomplished in block 132, and electronic information is converted to physical information presentation form. Now a physical sortation process is performed in block 133. Then in block 134 the transportation process, the mail entities are transported to a consolidator. A physical sortation process is performed in block 135. Then in block 136 the data is prepared and communicated to the Post. In block 137 (the transportation process), the mail entities are transported to the post. In entry block 138 the mail entities enter the postal environment.

FIG. 7 is a drawing of the recipient process flow. Delivery or pick up of the mail entities is performed in block 150. Then payment (cash on delivery) is (optionally) performed in block 151. Followed by incoming sortation in block 152, where physical information is converted to electronic information by a scanning process. At this point, internal delivery is accomplished in block 153. In block 154 data is prepared and communicated to the mailer. Then the mail entities are opened in block 155. Now processing of mail content is performed in block 156. In block 157 forwarding is accomplished by scanning the physical information and conversion into electronic information. In block 158 data is prepared and communicated to the mailer. In block 159 responses are made.

FIG. 8 is a drawing of mail box 320 with a Correct Address Information Record (CAIR) label 323. Mail box 320 has a housing 321 in which mail may be placed and removed, a door 322 having a CAIR label 323 affixed thereto and a mail indicator 324. CAIR label 323 will be more fully described in the description of FIG. 10. Mail box 320 is connected to post member 325.

FIG. 9 is a drawing of Correct Address Information Record (CAIR) label 323 with information fields PIᵢ₋₁, PIᵢ, GI. Address information that is present in the address block of most mail items (except those that are intended for saturation impersonal mass mailings, sometimes referred to as ‘unaddressed’, for every possible address and, as such, do not contain the name of the intended recipient) consists of two distinctly different parts, namely, Personal Information (PI) and Geographic Information (GI).

PI may consist of the following data elements. At least some of them are necessarily present:
<recipient's name>
<recipient's title>
<company name>
<company division>
<department name>
<internal company location code>
<recipient preferences>

GI may consist of the following data elements:
<vanity name>
<street range (number)>
<street name>
<city name>
<state/province/municipality name>
<Postal or ZIP code>
<Machine-readable postal code>
<country name>

Label 323 has a two-dimensional bar code 326 (such as Data Matrix) containing correct up-to-date PI/GI information (FIG. 1). Label 323 may be a Radio Frequency Identification Tag, electronic memory chip, read write memory controllable via wireless communication system from user's computer, etc. In the case of the wireless communication, the memory device will be equipped with an antenna. It should be expressly noted that CAIR information can also reside in a computer database accessible by a mail carrier, for example, through a wireless connection device such as a cell phone.

The above specification describes a new and improved method for capturing and processing event information in mail communications systems. It is realized that the above description may indicate to those skilled in the art additional ways in which the principles of this invention may be used without departing from the spirit. Therefore, it is intended that this invention be limited only the scope of the appended claims.

1. A method for capturing and processing event information in mail communications systems, said method comprising the steps of:
(A) capturing information present on a mail entity;
(B) capturing unique identity information present on a mail entity;
(C) detecting defects in the information and the unique identity information;
(D) classifying the detected defects;
(E) communicating the classified defects to interested parties using unique identity information as a reference; and
(F) applying the classified defects in order to correct information on future mail entities.

2. The method claimed in claim 1, wherein the interested party is a sender.

3. The method claimed in claim 1, wherein the interested party is a postal operator.

4. The method claimed in claim 1, wherein the interested party is a carrier.

5. The method claimed in claim 1, wherein the information captured in step (A) is address information.

6. The method claimed in claim 5, further including the step of: correcting the address information using a computerized address matching system.

7. The method claimed in claim 6, further including the step of: communicating the corrected address information to interested parties in real time.

8. The method claimed in claim 1, wherein defects in the captured information indicates requests regarding which information should be reported by a party who captured the information to a party requesting the information.

9. The method claimed in claim 8, wherein defects in the captured information are reported to the sender.

10. The method claimed in claim 8, wherein defects in the captured information are reported to a third party.

11. The method claimed in claim 9, wherein the third party is a law enforcement agency.

12. The method claimed in claim 1, wherein defects in the captured information are classified as to severity of the defect.

13. The method claimed in claim 1, wherein defects in the captured information are classified as to consequences of the defect.

14. The method claimed in claim 1, further including the step of: obtaining recipient preferences for delivery of the mail entity.

15. The method claimed in claim 14, wherein the preferences are selected from the names of people located at a address on the mail entity.

16. The method claimed in claim 15, wherein the preferences are selected from the date and time when delivery is requested.

17. The method claimed in claim 15, wherein the preferences are contained in a data base.

18. The method claimed in claim 15, wherein the data base is maintained by a party other than a postal operator or a carrier.

19. The method claimed in claim 15, further including the step of: placing a pointer at the recipient's mail box that indicates the location of the preferences in the data base.

20. The method for capturing and processing event information in mail communications systems, said method comprising the steps of:
(A) capturing address information from a mail entity;
(B) correcting the address information using a computerized address matching system;
(C) placing correct address information in a data base;
(D) marking a Business Reply Mail entity with an indicator of a new address;
(E) creating a unique identifier for the Business Reply Mail Entity;
(F) linking the identifier of the Business Reply Mail Entity with the identity of the original mail entity;
(G) mailing the Business Reply Mail entity to the sender;
(H) receiving the corrected address information from the carrier;
(I) linking the correct address information with the Business Reply Mail entity; and
(J) performing the action requested by the recipient.
